(19) United States
(12) Patent Application Publication
(10) Pub. No.: US 2025/0181724 A1
(43) Pub. Date: Jun. 5, 2025

(54) SYSTEMS AND METHODS FOR IDENTIFYING SOFTWARE FAULT VULNERABILITIES AND INSERTING FAULT COUNTERMEASURES

(71) Applicant: The MITRE Corporation, McLean, VA (US)

(72) Inventors: Julian Philippe LANSON, Brighton, MA (US); Eric Andrew KEDAIGLE, Arlington, MA (US); Gabriel PASCUALY, Cambridge, MA (US); Benjamin Todd JANIS, Cambridge, MA (US)

(73) Assignee: The MITRE Corporation, McLean, VA (US)

(21) Appl. No.: 18/960,860

(22) Filed: Nov. 26, 2024

Related U.S. Application Data
(60) Provisional application No. 63/604,650, filed on Nov. 30, 2023.

(51) Int. Cl. G06F 21/57; G06F 21/54

(52) U.S. Cl. CPC G06F 21/577; G06F 21/54; G06F 2221/033

(57) ABSTRACT

A method for automatically generating a compiled binary file with fault countermeasures includes compiling, by a compiler, a source code file to a first binary file; analyzing the first binary file to identify one or more fault vulnerabilities in the first binary file, wherein analyzing the first binary file to identify the one or more fault vulnerabilities includes: injecting a set of faults into the first binary file during a symbolic execution of the first binary file to generate a set of faulted states of the first binary file; and identifying the one or more fault vulnerabilities from the set of faulted states, wherein the one or more fault vulnerabilities are fault vulnerabilities that cause the first binary file to violate at least one security requirement; and compiling, by the compiler, the source code file to a second binary file, wherein the compiler inserts a set of fault countermeasures into the second binary file based on the identified one or more fault vulnerabilities, wherein the set of fault countermeasures protect the second binary file against the one or more fault vulnerabilities.

### CROSS REFERENCE TO RELATED APPLICATIONS

This application claims the benefit of U.S. Provisional Application No. 63/604,650, filed Nov. 30, 2023, the entire contents of which are hereby incorporated by reference.

### FIELD OF THE DISCLOSURE

This disclosure generally relates to faults in software, and more specifically to identifying fault vulnerabilities in binary files and inserting fault countermeasures in binary files to protect against the fault vulnerabilities.

### BACKGROUND OF THE DISCLOSURE

Fault induction is a technique that may be used to assess the robustness of software programs in handling and recovering from various types of faults and failures. Fault induction may include introducing faults and errors into a software program to simulate different scenarios that may lead to failures, such as crashes, data corruption, or unexpected behavior. One type of fault induction is adversarial fault induction, which focuses on deliberately injecting faults for the purpose of exploiting vulnerabilities in the software and breaking a software program. Fault countermeasures may then be inserted to protect against those vulnerabilities.

One approach for simulating fault induction in a software program is by using concrete execution where the software program is executed using specific input values or test cases. Faults may be injected during the software program's execution where the resulting output and execution behavior is then analyzed for potential fault vulnerabilities. However, concrete execution may be limited by the types of faults that can be injected, the number of faults that can be injected, and the overall time it takes to identify different fault vulnerabilities. Another approach for simulating fault induction is to analyze the code of a software program using symbolic execution, where symbolic values for variables are tracked as the code is executed. Various faults may be injected to the code of the software program during the symbolic execution, and the final results of the symbolic values may then be analyzed to determine if any fault vulnerabilities were detected as a result of the injected faults. However, symbolic execution is applied at higher-level representations of the code for a software program, such as at the source code level, which may limit the accuracy of the fault vulnerabilities that are identified and thus the fault countermeasures that are inserted into the code to protect against those fault vulnerabilities.

### SUMMARY OF THE DISCLOSURE

The present disclosure introduces a fault countermeasure application for addressing adversarial faults by inserting fault countermeasures that protect against various fault vulnerabilities. The fault countermeasure application may operate on binary files, instead of source code files, which increases the accuracy of the fault vulnerabilities detected in a binary file and the corresponding software program that results when executing the binary file. The fault countermeasure application may receive a source code file and compile that source code file to a binary file using a compiler corresponding to the programming language that the source code file is written in. The fault countermeasure application may then analyze the compiled binary file to identify fault vulnerabilities in the binary file. This may include injecting various faults into the binary file during a symbolic execution of the binary file. The injected faults may generate faulted states of the binary file, which the fault countermeasure application may use to identify fault vulnerabilities in the binary file. After the fault vulnerabilities are identified, the fault countermeasure application may recompile the original source code file to a second binary file. In compiling to the second binary file, the fault countermeasure application may cause the compiler to insert various fault countermeasures into the second binary file that protect against the fault vulnerabilities that were identified in the first binary file.

According to some embodiments, a method for automatically generating a compiled binary file with fault countermeasures includes compiling, by a compiler, a source code file to a first binary file; analyzing the first binary file to identify one or more fault vulnerabilities in the first binary file, wherein analyzing the first binary file to identify the one or more fault vulnerabilities comprises: injecting a set of faults into the first binary file during a symbolic execution of the first binary file to generate a set of faulted states of the first binary file; and identifying the one or more fault vulnerabilities from the set of faulted states, wherein the one or more fault vulnerabilities are fault vulnerabilities that cause the first binary file to violate at least one security requirement; and compiling, by the compiler, the source code file to a second binary file, wherein the compiler inserts a set of fault countermeasures into the second binary file based on the identified one or more fault vulnerabilities, wherein the set of fault countermeasures protect the second binary file against the one or more fault vulnerabilities.

Analyzing the first binary file to identify the one or more fault vulnerabilities may further include generating a reference trace representing a correct execution behavior of the first binary file. Identifying the one or more fault vulnerabilities may include identifying a location in the first binary file for each of the one or more fault vulnerabilities.

The symbolic execution of the first binary file may include providing a corrupted input to the first binary file, and wherein the one or more fault vulnerabilities comprises executing a software operation using the corrupted input. The set of faults may include at least one of an instruction skip, load corruption, a register operand substitution, and a control flow branch operand substitution.

The one or more fault vulnerabilities may include at least one of a stack overflow, calling a sensitive function, bypassing an authentication, leaking a key to an external interface, and a code injection. The set of faults may be injected at predefined locations of the first binary file. The set of fault countermeasures may be inserted at an intermediate representation level of the source code during the compilation. The set of fault countermeasures may be inserted at an assembly instruction level during the compilation.

The set of fault countermeasures may include at least one control flow integrity (CFI) countermeasure. The at least one CFI countermeasure may include a first CFI countermeasure between one or more different functions of the second binary file and a second CFI countermeasure within a single function of the second binary file.

The set of fault countermeasures may include a duplication of an assembly instruction. The second binary file may be linked with a third binary file to generate a machine-executable file, wherein the third binary file includes no fault countermeasures inserted by the compiler. The compiler may be configured to insert an initial set of fault countermeasures into the first binary file during the compilation of the source code.

According to some embodiments, a system for automatically generating a compiled binary file with fault countermeasures includes one or more processors; and a memory coupled to the one or more processors comprising instructions executable by the one or more processors to cause the system to: compile, using a compiler, a source code file to a first binary file; analyze the first binary file to identify one or more fault vulnerabilities in the first binary file, wherein analyzing the first binary file to identify the one or more fault vulnerabilities includes: injecting a set of faults into the first binary file during a symbolic execution of the first binary file to generate a set of faulted states of the first binary file; and identifying the one or more fault vulnerabilities from the set of faulted states, wherein the one or more fault vulnerabilities are fault vulnerabilities that cause the first binary file to violate at least one security requirement; and compile, using the compiler, the source code file to a second binary file, wherein the compiler inserts a set of fault countermeasures into the second binary file based on the identified one or more fault vulnerabilities, wherein the set of fault countermeasures protect the second binary file against the one or more fault vulnerabilities.

Analyzing the first binary file to identify the one or more fault vulnerabilities may further include generating a reference trace representing a correct execution behavior of the first binary file. Identifying the one or more fault vulnerabilities may include identifying a location in the first binary file for each of the one or more fault vulnerabilities.

The symbolic execution of the first binary file may include providing a corrupted input to the first binary file, and wherein the one or more fault vulnerabilities comprises executing a software operation using the corrupted input. The set of faults may include at least one of an instruction skip, load corruption, a register operand substitution, and a control flow branch operand substitution.

The one or more fault vulnerabilities may include at least one of a stack overflow, calling a sensitive function, bypassing an authentication, leaking a key to an external interface, and a code injection. The set of faults may be injected at predefined locations of the first binary file. The set of fault countermeasures may be inserted at an intermediate representation level of the source code during the compilation. The set of fault countermeasures may be inserted at an assembly instruction level during the compilation.

The set of fault countermeasures may include at least one control flow integrity (CFI) countermeasure. The at least one CFI countermeasure may include a first CFI countermeasure between one or more different functions of the second binary file and a second CFI countermeasure within a single function of the second binary file.

The set of fault countermeasures may include a duplication of an assembly instruction. The second binary file may be linked with a third binary file to generate a machine-executable file, wherein the third binary file includes no fault countermeasures inserted by the compiler. The compiler may be configured to insert an initial set of fault countermeasures into the first binary file during the compilation of the source code.

According to some embodiments, one or more computer-readable non-transitory storage media embodies software for automatically generating a compiled binary file with fault countermeasures, the software including instructions operable when executed to: compile, using a compiler, a source code file to a first binary file; analyze the first binary file to identify one or more fault vulnerabilities in the first binary file, wherein analyzing the first binary file to identify the one or more fault vulnerabilities includes: injecting a set of faults into the first binary file during a symbolic execution of the first binary file to generate a set of faulted states of the first binary file; and identifying the one or more fault vulnerabilities from the set of faulted states, wherein the one or more fault vulnerabilities are fault vulnerabilities that cause the first binary file to violate at least one security requirement; and compile, using the compiler, the source code file to a second binary file, wherein the compiler inserts a set of fault countermeasures into the second binary file based on the identified one or more fault vulnerabilities, wherein the set of fault countermeasures protect the second binary file against the one or more fault vulnerabilities.

### BRIEF DESCRIPTION OF THE FIGURES

The invention will now be described, by way of example only, with reference to the accompanying drawings, in which:

FIG. 1 illustrates a method for automatically generating a compiled binary file with fault countermeasures.

FIG. 2A illustrates a schematic of an example for automatically generating a compiled binary file with fault countermeasures.

FIG. 2B illustrates a schematic of an example of how the fault analysis component may identify the fault vulnerabilities in a compiled binary file.

FIG. 2C illustrates a schematic of an example method that may be performed by a compiler.

FIG. 3 illustrates a system schematic of the different components that may be involved in identifying the fault vulnerabilities in a compiled binary file.

FIG. 4 illustrates various sections of an exemplary configuration file for the fault countermeasure application.

FIG. 5 illustrates an example computer system.

### DESCRIPTION OF EXAMPLE EMBODIMENTS

Fault induction is a technique that may be used to assess the robustness of software programs in handling and recovering from various types of faults and failures. Fault induction may include introducing faults and errors into a software program to simulate different scenarios that may lead to failures, such as crashes, data corruption, or unexpected behavior. The faults may help testing, debugging, or quality assurance processes to identify and correct fault vulnerabilities and weaknesses in the software program. As referenced herein, a fault is a defect or abnormality in the execution of a software program that causes the software program to behave unexpectedly or produce incorrect or unintended results. A fault vulnerability as referenced herein is the unexpected or incorrect behavior that results from a fault. For example, a fault may be that an executable instruction in a software program is skipped, and a fault vulnerability may be that an authentication process is bypassed or a sensitive function is called incorrectly.

One type of fault induction is adversarial fault induction, which focuses on deliberately injecting faults for the purpose of exploiting vulnerabilities in the software and breaking a software program. Adversarial faults may include initiating a change at the hardware level to introduce a fault in the software program that causes an unintended or incorrect behavior. For example, an electrically powered security token that includes cryptographic information may be used to authenticate a user. The electrical power provided to the security token may then be adjusted to an amount that allows the security token to operate but is insufficient for the security token to operate optimally. A malicious authentication request may be provided to the security token while the security token is provided insufficient electrical power. Because of the insufficient electrical power, the security token may accidentally skip an executable instruction which then causes the security token to mishandle the authentication request. As another example, a laser may be shined at a mobile device when inputting a passcode that causes the mobile device to accidentally bypass an authentication process and thus mistake an incorrect passcode as the correct passcode. Addressing and protecting against such adversarial faults may help cover security weaknesses and improve resistance to malicious attacks.

The present disclosure introduces a fault countermeasure application for addressing adversarial faults by inserting fault countermeasures that protect against various fault vulnerabilities. The fault countermeasure application may operate on binary files, instead of source code files, which increases the accuracy of the fault vulnerabilities detected in a binary file and the corresponding software program that results when executing the binary file. In a similar manner, the fault countermeasure application may also insert fault countermeasures directly into binary files, which may increase the efficiency of the countermeasures in protecting against fault vulnerabilities. Operating on binary files may also allow the fault countermeasure application to detect a larger range of different fault vulnerabilities compared to when operating on source code files.

The fault countermeasure application may receive a source code file and compile that source code file to a binary file using a compiler corresponding to the programming language that the source code file is written in. The compiler may also be modified to be able to insert fault countermeasures during the process of compiling the source code file to a binary file. The fault countermeasure application may then analyze the compiled binary file to identify fault vulnerabilities in the binary file. This may include injecting various faults into the binary file during a symbolic execution of the binary file. The injected faults may generate faulted states of the binary file, which the fault countermeasure application may use to identify fault vulnerabilities in the binary file. After the fault vulnerabilities are identified, the fault countermeasure application may recompile the original source code file to a second binary file. In compiling to the second binary file, the fault countermeasure application may cause the compiler to insert various fault countermeasures into the second binary file that protect against the fault vulnerabilities that were identified in the first binary file.

In the following description of the various examples, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some examples also relates to a device for performing the operations herein. This device may be specially constructed for the required purposes, or it may comprise a general purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing distinct functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

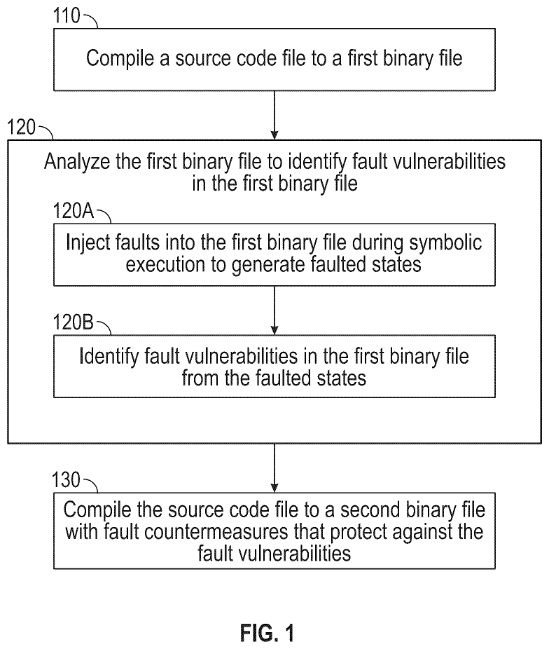

FIG. 1 illustrates a method 100 for automatically generating a compiled binary file with fault countermeasures. In various embodiments, the steps of method 100 as described herein may be executed by a fault countermeasure application, which may be implemented as any appropriate software application, such as a command-line application. The method 100 may include step 110, where the fault countermeasure application may compile a source code file to a first binary file. The source code file may be a text file that includes human-readable instructions and statements written in a particular programming language. The fault countermeasure application may receive the source code file from a remote device via an electronic connection with the remote device. The fault countermeasure application may also receive the source code file directly from a user. In various embodiments, the fault countermeasure application may include multiple compilers to allow the fault countermeasure application to be applicable to source code files written in various compiled programming languages. The fault countermeasure application may then select the compiler corresponding to the programming language that a source code file is written in and execute step 110 by compiling the source code file using that compiler. The fault countermeasure application may then execute the subsequent steps of method 100 with respect to the compiler used to execute step 110.

The compiler used to compile the source code file may be a modified compiler that translates the high-level source code into a lower level representation, such as a binary representation, assembly (a textual representation of binary data), and/or intermediate representation (which can be textual or binary), and also inserts various fault countermeasures into the compiled binary file. While the fault countermeasures that are inserted may be based on the fault vulnerabilities identified in the first binary file (as described further herein), the compiler may also insert an initial set of fault countermeasures into the first binary file at step 110. The initial set of fault countermeasures may protect the first binary file against various common or predetermined fault vulnerabilities, which may be determined in any appropriate manner. Common fault vulnerabilities may be determined based on data regarding the fault vulnerabilities that are most common in the binary files compiled from certain source code files. For example, the source code file may be directed to a web-based application, and such source code files may be known to commonly suffer from certain fault vulnerabilities. Thus, the initial fault countermeasures that are inserted may aim to protect against those common fault vulnerabilities. Alternatively, there may be certain fault vulnerabilities that pose a substantial enough security risk that they should be accounted for directly upfront. Thus, the initial fault countermeasures may also be inserted to protect against such sensitive vulnerabilities.

After the source code file is compiled to the first binary file, at step 120, the fault countermeasure application may analyze the first binary file to identify fault vulnerabilities in the first binary file. As described above, fault vulnerabilities may be unexpected or incorrect behavior from the software program that results from executing the binary file, where the fault vulnerabilities may results from faults that are injected into the binary file. Thus, step 120 may allow the fault countermeasure application to identify those vulnerabilities and then remedy the vulnerabilities in subsequent steps.

To analyze the first binary file, at step 120A, the fault countermeasure application may inject faults into the first binary file during symbolic execution of the first binary file to generate faulted states of the first binary file. Symbolic execution may be a type of software analysis that executes the first binary file using symbolic values. That is, the inputs for the first binary file may be represented symbolically as variables and/or expressions, and as the binary file is executed, a symbolic execution engine tracks the symbolic values and determines the end results of the symbolic values at each executable instruction of the binary file and also at the end of the binary file. The final results of the variables may then be analyzed to determine the output of the first binary file for various cases and inputs.

As the fault countermeasure application performs the symbolic execution of the first binary file, the fault countermeasure application may inject a set of faults into the first binary file. That is, the fault countermeasure application may intentionally introduce various execution defects or abnormalities to simulate ways that the first binary file may become corrupted due to various attacks from malicious actors. For example, these faults may include an instruction skip (where any single executable instruction in the first binary file is skipped), load corruption (where a load or input to the first binary file is corrupted in some way), a register operand substitution (where an operand in an executable instruction is changed, e.g., register R1 plus register R2 becomes register R1 plus register R3), or a control flow branch operand substitution (where the branching condition of an executable instruction is changed, e.g., jump to instruction location if branch condition is equal changed to jump to instruction if branch condition is unequal), among many others. Optionally, the fault countermeasure application implements an instruction skip by stepping the state up until that instruction and incrementing the program counter by the instruction size. In various embodiments, the fault countermeasure application may inject multiple different faults during any particular execution of the first binary file.

The fault countermeasure application injecting the faults into the first binary file may generate various faulted states of the binary file, where the file execution enters an unexpected execution state due to the injected faults. For example, the injected fault may be an instruction skip, and the faulted state of the first binary file may be an execution state where some executable instruction of the first binary file has failed to execute. The injected fault may also include providing a corrupted input to the first binary file, and the faulted state may be processing the corrupted input assuming the input was clean. The injected fault may also be a combination of multiple individual faults, such as an instruction skip together with a corrupted input, and the faulted state may be an execution state where an executable instruction was skipped and a corrupted input was processed.

As mentioned above, the faults injected by the fault countermeasure application may simulate various attacks from malicious actors. For example, the injected faults may simulate an actor that is trying to cause the first binary file to skip a certain function call, where the function may perform certain authentication operations, and skipping the function call may allow an actor to bypass the authentication. Alternatively, the injected faults may simulate an actor that is trying to cause a security/authentication key to be leaked to an external interface, or to get the security/authentication key to be overwritten with the actor's own custom key. The injected faults may also simulate an actor that is trying to inject malicious code into the first binary file that may cause execution of the binary file to perform various unintended operations.

After injecting the faults, at step 120B, the fault countermeasure application may identify the fault vulnerabilities in the first binary file from the faulted states. As described above, the fault vulnerabilities may be the unexpected or incorrect execution behaviors that result from the faults injected to the first binary file. Using the above example, if the injected fault is an instruction skip with the faulted state being an executable instruction being skipped and/or a corrupted input being processed, the fault vulnerability may be, for example, a stack overflow occurs in memory, a sensitive function is executed unintentionally or incorrectly, authentication or security checks are bypassed, security keys are leaked to an external interface, or external/unauthorized code is injected and executed from within the first binary file which may allow an unauthorized actor to launch a root shell or perform other operations. Additionally, the fault countermeasure application may also identify the specific location in the first binary file where each of the identified fault vulnerability originates from. In various embodiments, this may include identifying the specific executable instruction, or set of executable instructions, that causes each of the fault vulnerabilities.

In various embodiments, the fault countermeasure application may identify all of the fault vulnerabilities that are present in the first binary file. In various other embodiments, the fault countermeasure application may only identify certain fault vulnerabilities, which may be the case as certain fault vulnerabilities do not pose a substantial enough security risk to offset the performance loss from inserting the countermeasures that protect against those fault vulnerabilities. In such cases, the fault vulnerabilities that the fault countermeasure application identifies as part of step 120B may be the fault vulnerabilities that specifically cause the first binary file to violate at least one security requirement. The fault countermeasure application may receive a set of security requirements that specifies the security functionalities and properties that the first binary file should satisfy. For example, the security requirements may require that input data is not processed unless the input data is correctly authenticated, or that certain operations are executed and not skipped for any reason. The fault countermeasure application may then only identify the fault vulnerabilities that would cause the first binary file to violate at least one of the security requirements. Optionally, a user may define a set of conditions (also referred to herein as “discriminators”) that the user would like to monitor for during analysis. Conditions can be, for example, “a certain function is called” or “a certain variable gets written to a certain place in memory.” The security requirements may be translated to these conditions, and then may be provided to the fault countermeasure application as part of its configuration file

As part of identifying the fault vulnerabilities at step 120B, the fault countermeasure application may also generate a report that includes the identified fault vulnerabilities. The report may be in a human-readable format, such as a JavaScript Object Notation (JSON) format. The fault vulnerability report may include a list of all the executable instructions in the first binary file. Each of the executable instructions may be associated with a fault that was injected at step 120A which would affect that executable instruction, and the corresponding fault vulnerability that would result from that fault. For example, one of the executable instructions may be associated with an instruction skip fault that was injected by the fault countermeasure application at step 120A, as well as a fault vulnerability that an authentication operation would be bypassed as a result of the execution instruction being skipped due to the instruction skip fault. The report may be used by the fault countermeasure application to determine fault countermeasures. The fault countermeasure application may consider both a fault that is detected and the specific instruction that is vulnerable to the fault in order to choose a countermeasure. For example, if an instruction is vulnerable to an instruction skip, the fault countermeasure application may duplicate the instruction so that the instruction runs twice. As another example, if an instruction is vulnerable to a data corruption, the fault countermeasure application may add additional checks to the destination register of the instruction.

After the fault vulnerabilities are identified, at step 130, the fault countermeasure application may re-compile the source code file to a second binary file. The re-compilation of the source code file to the second binary file may account for the fault vulnerabilities that were identified in the first binary file at step 120B by inserting various fault countermeasures during re-compilation that protect the second binary file against the fault vulnerabilities identified in the first binary file. As described above, the fault countermeasure application may compile the source code file using a modified compiler that translates the high-level source code to lower-level binary representation and also inserts various fault countermeasures during re-compilation that protect the compiled binary file. In compiling the second binary file, the fault countermeasure application may compile the source code file using the same compiler as that used to compile the first binary file at step 110. The fault countermeasure application may then cause the compiler to insert the fault countermeasures corresponding to the identified fault vulnerabilities to protect the second binary file from the identified fault vulnerabilities. The fault countermeasures inserted at step 130 may also be additive with respect to any other fault countermeasures that were inserted in prior compiled binary files. That is, when compiling the second binary file, the initial set of fault countermeasures that may have been inserted into the first binary file at step 110 may also be inserted into the second binary file in addition to the fault countermeasures that are inserted to protect against the fault vulnerabilities identified at step 120B. This way, the second binary file may include fault countermeasures that protect against more fault vulnerabilities than the first binary file.

The specific fault countermeasures that are inserted may depend on and correspond to the particular faults that led to the fault vulnerabilities identified at step 120B. For example, a fault vulnerability where an authentication is bypassed may result from an instruction skip fault. As such, the fault countermeasure application may cause the compiler to insert an instruction duplication to protect against any single executable instruction being skipped. As another example, a control flow fault vulnerability that causes an incorrect function to be called or a function to be called incorrectly may result from a branch operand substitution fault. As such, the fault countermeasure application may cause the compiler to insert one or more control flow integrity (CFI) countermeasures between different functions and/or within a single function. The CFI countermeasures may convert a branch instruction to a multi-step process by introducing executable instructions for setting a destination memory address in a particular register, and then when the branching instruction is completed, confirming if the memory address was set correctly in the register, and only proceeding with subsequent instructions if the memory address was set correctly in the register. These CFI countermeasures may be introduced outside the scope of any particular function to help protect against the incorrect function from being called, but may also be introduced inside the scope of a particular function to help protect against a particular function from being executed incorrectly.

The fault countermeasures may also be inserted at different levels of the compilation process to the second binary file. That is, certain fault countermeasures may be inserted during an intermediate representation level of the compilation process, while other fault countermeasures may be inserted at the assembly level of the compilation process. For example, the CFI countermeasures described above may be inserted during the intermediate representation level while the instruction duplication countermeasure may be inserted during the assembly level. Since the compiler of the fault countermeasure application may insert multiple fault countermeasures, this may mean that when the source code file is compiled to the second binary file, different fault countermeasures are inserted at different levels of that single compilation.

In various embodiments, the second binary file with the fault countermeasures may be linked with other binary files to generate a final executable program. In such cases, the other binary files that the second binary file is linked to may or may not have any fault countermeasures inserted into them. That is, the second binary file with the fault countermeasures may be linked with other binary files that also have fault countermeasures, but the second binary file may also be linked with other binary files that do not have any fault countermeasures. This means that inserting the fault countermeasures do not affect the linking functionality of the second binary file.

In various embodiments, the flow of method 100 may also loop back from step 130 to step 120. That is, after the source code file is compiled with fault countermeasures that protect against identified fault vulnerabilities, the fault countermeasure application may analyze the binary file again to potentially identify additional fault vulnerabilities, in which case the source code file may subsequently be compiled again with additional fault countermeasures to protect against the additional fault vulnerabilities. This loop may allow the fault countermeasure application to continuously analyze a compiled binary file for fault vulnerabilities, and if any are identified, recompile the source code file to a new binary file and insert additional fault countermeasures to further protect the resulting compiled binary file. The loop may continue until a predetermined condition is satisfied, such as when no more fault vulnerabilities are identified in the most recent binary file, after a certain number of iterations of the loop has been executed, or if the number of fault vulnerabilities is below a predetermined amount, among many others.

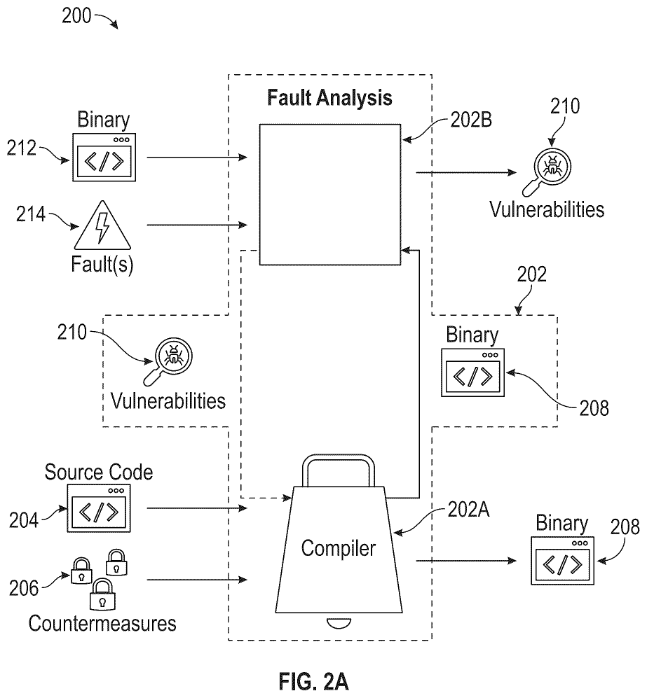

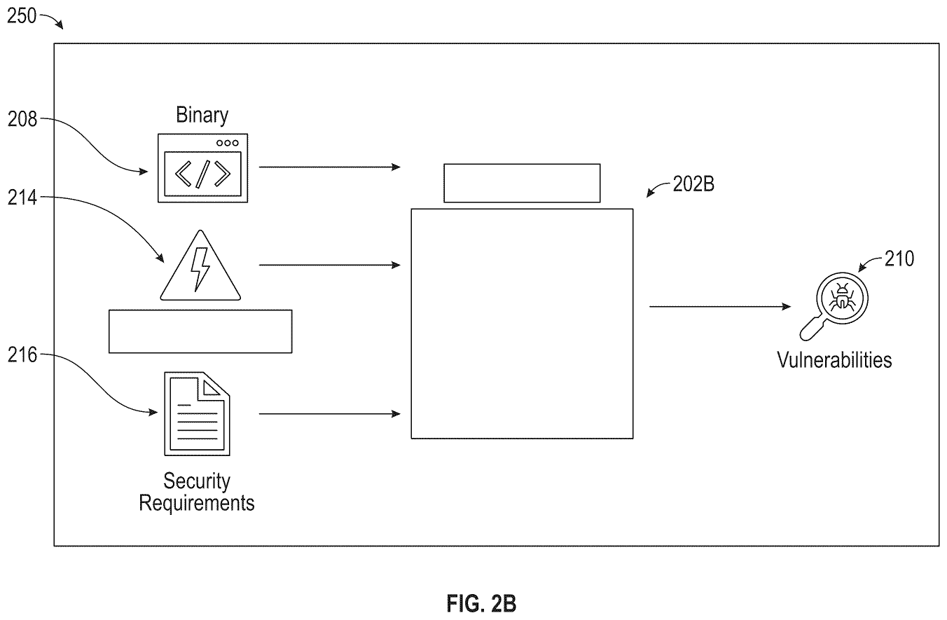

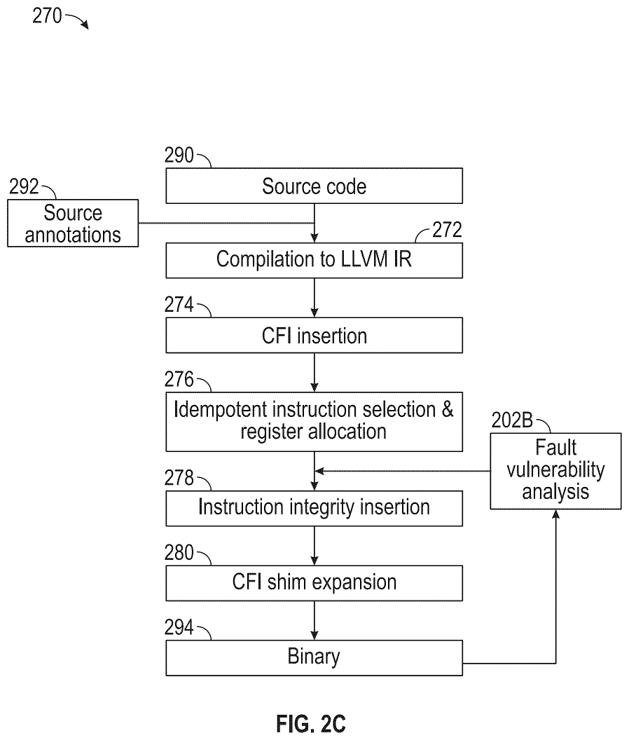

FIG. 2A illustrates a schematic 200 of an example for automatically generating a compiled binary file with fault countermeasures. The schematic 200 includes a fault countermeasure application 202 which may analyze compiled binary files for fault vulnerabilities and insert fault countermeasures into compiled binary files. As illustrated, the fault countermeasure application 202 may include a compiler 202A that may compile source code files to binary files and insert fault countermeasures into those binary files. Although the compiler 202A is illustrated as a single compiler, the fault countermeasure application 202 may include multiple compilers corresponding to different programming languages. The fault countermeasure application 202 may also include a fault analysis component 202B that may analyze binary files to identify fault vulnerabilities in the binary files. In various embodiments, the fault countermeasure application 202 as illustrated in the schematic 200 may execute one or more steps of method 100 as described above with respect to FIG. 1.

In various embodiments, the fault countermeasure application 202 may be initiated with either a source code file 204 or a precompiled binary file 212. That is, the fault countermeasure application 202 may initially receive and/or load from memory a source code file 204, where the compiler 202A compiles that file to a binary file 208 that includes a set of fault countermeasures 206. In this case, receiving the source code file 204 and compiling the file to a binary file 208 with fault countermeasures 206 may correspond to step 110 of method 100. The fault analysis component 202B may then analyze the binary file 208 by injecting various faults 214 to identify fault vulnerabilities 210 in the binary file 208, which may correspond to step 120 of method 100. The identified vulnerabilities 210 may then be provided back to the compiler 202A which recompiles the source code file 204 to a new binary file with additional fault countermeasures that protect the new binary file against the identified fault vulnerabilities 210, which may correspond to step 130 of method 100. The process may then be repeated until a final version of the compiled binary file 208 is generated as an output. During that process, the identified vulnerabilities 210 may also be generated as an output from the fault countermeasure application 202, such as in the form of a report as described above with respect to FIG. 1. In various embodiments, the binary file 208 compiled by the compiler 202A and/or the vulnerabilities 210 identified by the fault analysis component 202B may be generated as an output after each iteration, which may mean multiple binary files and/or vulnerabilities are generated as output for any particular application of the fault countermeasure application.

Alternatively, the fault countermeasure application 202 may initially receive a precompiled binary file 212, where the fault analysis component 202B analyzes that file by injecting various faults 214 to identify fault vulnerabilities 210. The precompiled binary file 212 may be compiled from an existing source code file 204. As such, the identified vulnerabilities 210 may then be provided to the compiler 202A which receives and compiles the source code file 204 to a new binary file 208 and inserts a set of fault countermeasures 206. The compiled binary file 208 may then be provided to the fault analysis component 202B to identify any additional fault vulnerabilities, which may include injecting the faults 214 to the binary file 208, but may also include injecting additional faults to the binary file 208. The process may then be repeated until a final version of the binary file 208 is generated as output. Thus, the fault countermeasure application 202 may be initiated with either a source code file or a compiled binary file, and in either case, may continuously compile a source code file to a binary file with fault countermeasures and also analyze the compiled binary file to identify additional fault vulnerabilities until a binary file is finally generated as an output with fault countermeasures for a variety of fault vulnerabilities.

FIG. 2B illustrates a schematic 250 of an example of how the fault analysis component may identify the fault vulnerabilities in a compiled binary file. As described above, the fault analysis component 202B may analyze a compiled binary file 208 by injecting various faults 214 to the file to identify fault vulnerabilities 210. As described above with respect to FIG. 1, in various embodiments, the fault analysis component 202B may only identify certain fault vulnerabilities 210 that cause the binary file 208 to violate at least one security requirement 216. As such, the fault analysis component 202B may also receive a set of security requirements 216 and determine if injecting the faults 214 into the binary file 208 results in any fault vulnerabilities that cause the binary file 208 to violate at least one of the security requirements 216. If so, the fault analysis component 202B may then identify those fault vulnerabilities 210, which may be generated as an output of the fault countermeasure application and/or provided to the compiler 202A to help compile a new binary file with fault countermeasures for the identified fault vulnerabilities 210.

FIG. 2C illustrates an example method 270 that may be performed by the compiler 202A. At step 272, source code 290 and source annotations 292 are compiled to an intermediate representation, such as LLVM intermediate representation, according to known techniques. At step 274, one or more CFI countermeasures are inserted between different functions and/or within a single function, as described above, into the intermediate representation. Step 276 includes idempotent instruction selection, which takes an idempotent instruction (an instruction that cannot use a register value that it writes to) and selects a binary instruction to match it. Step 276 also includes register allocation. Step 278 include instruction integrity insertion in which one or more countermeasures are inserted to the idempotent instructions. Step 280 includes CFI shim expansion, which enables linking of multiple binary files. The result of step 280 is a binary file 294 that can then be analyzed by the fault analysis component 202B. Optionally, information about faults identified by fault analysis component 202B can be provided to compiler 202A for use in step 288 such that step 288 can include inserting countermeasures based on faults identified by fault analysis component 202B.

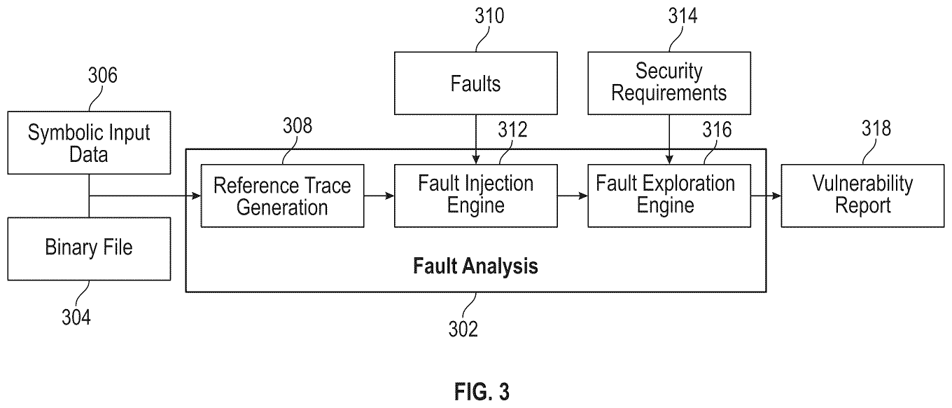

FIG. 3 illustrates a system schematic 300 of the different components that may be involved in identifying the fault vulnerabilities in a compiled binary file. The system schematic 300 may focus on the fault analysis component 302 of a fault countermeasure application that analyzes a binary file 304 to identify the fault vulnerabilities. The various components of the system schematic 300 may be implemented as software modules that are associated with the fault analysis component 302. For example, the various components may be implemented as a set of functions or as a software library that is integrated into the fault analysis component 302 and/or the fault countermeasure application. As described above with respect to FIG. 1, the fault countermeasure application, and thus the fault analysis component 302, may perform a symbolic execution of the binary file 304 and thus may receive symbolic input data 306 to use to evaluate the binary file 304. That is, the fault analysis component 302 may receive symbolic variables or expressions that are tracked during execution of the binary file 304, or the fault analysis component 302 may receive specific values that the binary file should be executed with.

In analyzing the binary file 304 to identify potential fault vulnerabilities, the fault analysis component 302 may perform a reference trace generation 308 on the binary file 304 to obtain a reference trace representing an execution of the binary file 304 with no faults. Reference trace generation 308 may occur before faults are injected. The fault analysis component 302 may then use the reference trace as a control execution to represent the correct execution behavior of the binary file 304. That is, the fault analysis component 302 may compare a faulted execution of the binary file 304 with the reference trace to help identify the fault vulnerabilities in the binary file, as described further below.

A fault injection engine 312 of the fault analysis component 302 may then inject various faults 310 into the binary file 304. The faults may be predefined and integrated as part of the fault injection engine 312, or the faults may be received from an external source, such as from a remote device or a user, or read from a separate file. The fault injection engine 312 may also inject the faults 310 at specific predefined locations in the binary file 304, such as in a specific function. As described above with respect to FIG. 1, the injected faults may generate faulted states of the binary file 304.

The faulted states may then be provided to a fault exploration engine 316 which may compare the execution behavior of the binary file 304 in the faulted states with the correct execution behavior of the reference trace generated at 308 to determine the fault vulnerabilities that resulted from the faults. The fault exploration engine 316 may then analyze the fault vulnerabilities to determine if any of the security requirements 314 are violated by the fault vulnerabilities. The security requirements 314 may be predefined and integrated as part of the fault exploration engine 316, received from an external source such as a remote user, or read from a separate file. In various embodiments, the fault exploration engine 316 may identify various fault vulnerabilities, but may discard vulnerabilities that do not violate any of the security requirements 314. The fault vulnerabilities that are retained may then be included in a vulnerability report 318 that is generated as an output. The fault vulnerabilities that are retained may also be provided to a compiler of the fault countermeasure application to allow the compiler to recompile a source code file corresponding to the binary file 304 to generate a new binary file that includes fault countermeasures that protect against the fault vulnerabilities identified by the fault exploration engine 316.

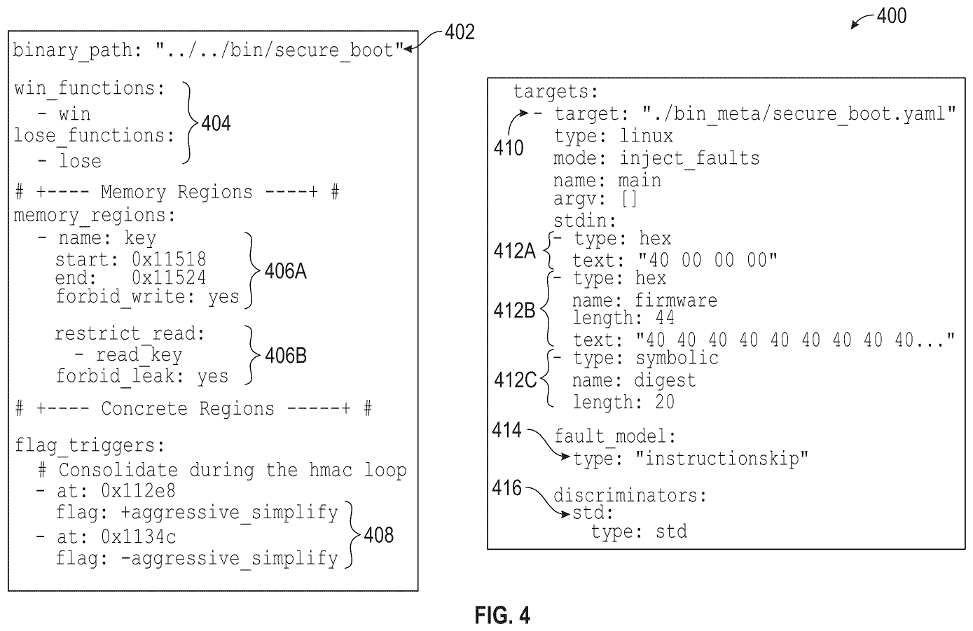

FIG. 4 illustrates various sections of an exemplary configuration file 400 for the fault countermeasure application. The illustrated sections of the configuration file 400 may configure the files that the fault countermeasure application analyzes and accesses as well as certain properties regarding the fault vulnerability analysis that the application may perform. In various embodiments, the exemplary configuration file 400 may be directed to configuring the fault analysis component of a fault countermeasure application. The configuration file 400 may include a file path 402 to a binary file that the fault countermeasure application should analyze for fault vulnerabilities. In this example, the file path 402 to the binary file being specified explicitly may mean that the fault countermeasure application is initiated with a precompiled binary file instead of a source code file, or that a binary file compiled from a source code file is not automatically provided to the fault analysis component of the fault countermeasure application and is instead accessed manually.

The exemplary configuration file 400 may also specify certain functions that, if called by the binary, count as a “win” or a “loss”. For example, the user may define the “auth_succeed” function as a “win function”, which means that when the binary calls “auth_succeed” in simulation in response to a fault, the fault countermeasure application will record it as a fault vulnerability. The configuration file 400 may also specify memory regions 406A and 406B with certain restrictions, which may correspond with a subset of the security requirements that execution of the binary file at the file path 402 should adhere to. Specifically, a first memory region 406A may be associated with a key that should not be written to, while a second memory region 406B may be associated with another key that is restricted to only allow read access and should not be leaked to any external interfaces. The fault countermeasure application may analyze the binary file at the file path 402 to detect whether any of those restrictions or security requirements are violated. The configuration file 400 may also specify certain execution properties for the fault countermeasure application when analyzing the binary file at the file path 402, such as how to simplify state expressions in cryptographic code that may be in the binary file.

In various embodiments, the binary file at the file path 402 may receive an input during execution, which in this example may be a firmware that should be booted from memory. As such, the exemplary configuration file 400 may include a second file path 410 to the location of the firmware file that is to be provided as input to the binary file at the file path 402. However, the firmware at the second file path 410 may be a corrupted firmware to simulate a potential attack by a malicious actor that aims to have the binary file at the file path 402 boot a corrupted firmware.

The configuration file 400 may also specify various additional inputs that will be provided to the binary file at the file path 402. Specifically, the input may include a first section 412A with the length of the firmware data in hexadecimal format. The input may also include a second section 412B with a sequence of data corresponding to the firmware that should be booted, with the data also being specified in hexadecimal format. That is, the firmware may be represented by the sequence of data “40 40 40 40 40 . . . ”, although it may be noted that this is purely exemplary data and not representative of what actual firmware data may be. The input may also include a third section 412C that specifies the firmware data may include a 20 byte digest section at the end of the firmware data, where the digest can include any data. The digest section may correspond to an authentication code that should be included with the firmware data for determining whether the firmware data is authentic and should be booted from memory. The third section 412C of the input may also be specified as symbolic, which may mean the fault countermeasure application will analyze the binary file with all possible values for the 20 byte digest to determine if any particular digest results in a fault vulnerability.

The configuration file 400 may also specify the type of fault that will be injected when executing the binary file at the file path 402 will be an instruction skip fault 414. Thus, for this exemplary configuration file 400, the fault countermeasure application may analyze the binary file at the file path 402 to determine whether a corrupted firmware at the second file path 410 would get booted assuming that any single instruction can get skipped during execution. If the corrupted firmware is booted, that may mean the binary file at the file path 402 includes a fault vulnerability of executing a software operation using corrupted input. The fault countermeasure application may also determine if either the corrupted firmware or a skipped instruction causes execution of the binary file to violate any of the restrictions for the memory regions 406A and 406B. [ ]

The configuration file 400 may include one or more discriminators 416, which as noted above defines the set of conditions that the user wants the fault countermeasure application to look for during execution. In the illustrated example, “std” is a short-hand for a standard set of conditions. Example conditions, which may or may not be included in a standard set, can include “look for any time a win/lose function is called” or “look for anytime the key is passed as the argument to a function.” The faulted states will then get tagged with these discriminators, and the user will be able to see which states triggered them and which states did not.

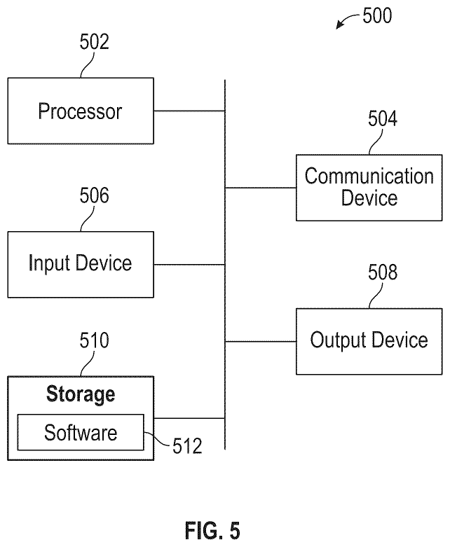

FIG. 5 illustrates an example of a computing system 500, in accordance with one or more examples of the disclosure. Computing system 500 can be used for performing one or more steps of method 100 of FIG. 1, for executing the fault countermeasure application 202 of FIG. 2A, and/or for executing the fault analysis components 202B of FIG. 2B and 302 of FIG. 3. Computing system 500 can be a computer connected to a network. Computing system 500 can be a client computer or a server. As shown in FIG. 5, computing system 500 can be any suitable type of microprocessor-based device, such as a personal computer, workstation, server, or handheld computing device (portable electronic device) such as a phone or tablet, or dedicated device. The computing system can include, for example, one or more of processors 502, input device 505, output device 508, storage 510, and communication device 504. Input device 505 and output device 508 can generally correspond to those described above and can either be connectable or integrated with the computer.

Input device 505 can be any suitable device that provides input, such as a touch screen, keyboard or keypad, mouse, or voice-recognition device. Output device 508 can be any suitable device that provides output, such as a touch screen, haptics device, or speaker.

Storage 510 can be any suitable device that provides storage (also referred to herein as memory), such as an electrical, magnetic, or optical memory, including a RAM, cache, hard drive, removable storage disk, or other non-transitory computer readable medium. Communication device 504 can include any suitable device capable of transmitting and receiving signals over a network, such as a network interface chip or device. The components of the computing system can be connected in any suitable manner, such as via a physical bus or wirelessly.

Processor(s) 502 can be any suitable processor or combination of processors, including any of, or any combination of, a central processing unit (CPU), field-programmable gate array (FPGA), and application-specific integrated circuit (ASIC). Software 512, which can be stored in storage 510 and executed by processor 502, can include, for example, the programming that embodies the functionality of the present disclosure (e.g., as embodied in the devices as described above).

Software 512 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 510, that can contain or store programming for use by or in connection with an instruction execution system, apparatus, or device.

Software 512 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Computing system 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, TI or T3 lines, cable networks, DSL, or telephone lines.

Computing system 500 can implement any operating system suitable for operating on the network. Software 512 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific examples. However, the illustrative discussions above are not intended to be exhaustive or to limit the invention to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the endoscope of the disclosure and examples as defined by the claims. Finally, the entire disclosure of the patents and publications referred to in this application are hereby incorporated herein by reference.

1. A method for automatically generating a compiled binary file with fault countermeasures, comprising:
compiling, by a compiler, a source code file to a first binary file;
analyzing the first binary file to identify one or more fault vulnerabilities in the first binary file, wherein analyzing the first binary file to identify the one or more fault vulnerabilities comprises:
injecting a set of faults into the first binary file during a symbolic execution of the first binary file to generate a set of faulted states of the first binary file; and
identifying the one or more fault vulnerabilities from the set of faulted states, wherein the one or more fault vulnerabilities are fault vulnerabilities that cause the first binary file to violate at least one security requirement; and
compiling, by the compiler, the source code file to a second binary file, wherein the compiler inserts a set of fault countermeasures into the second binary file based on the identified one or more fault vulnerabilities, wherein the set of fault countermeasures protect the second binary file against the one or more fault vulnerabilities.

2. The method of claim 1, wherein analyzing the first binary file to identify the one or more fault vulnerabilities further comprises generating a reference trace representing a correct execution behavior of the first binary file.

3. The method of claim 1, wherein identifying the one or more fault vulnerabilities comprises identifying a location in the first binary file for each of the one or more fault vulnerabilities.

4. The method of claim 1, wherein the symbolic execution of the first binary file comprises providing a corrupted input to the first binary file, and wherein the one or more fault vulnerabilities comprises executing a software operation using the corrupted input.

5. The method of claim 1, wherein the set of faults comprises at least one of an instruction skip, load corruption, a register operand substitution, and a control flow branch operand substitution.

6. The method of claim 1, wherein the one or more fault vulnerabilities comprise at least one of a stack overflow, calling a sensitive function, bypassing an authentication, leaking a key to an external interface, and a code injection.

7. The method of claim 1, wherein the set of faults are injected at predefined locations of the first binary file.

8. The method of claim 1, wherein the set of fault countermeasures are inserted at an intermediate representation level of the source code during the compilation.

9. The method of claim 1, wherein the set of fault countermeasures are inserted at an assembly instruction level during the compilation.

10. The method of claim 1, wherein the set of fault countermeasures comprises at least one control flow integrity (CFI) countermeasure.

11. The method of claim 10, wherein the at least one CFI countermeasure comprises a first CFI countermeasure between one or more different functions of the second binary file and a second CFI countermeasure within a single function of the second binary file.

12. The method of claim 1, wherein the set of fault countermeasures comprises a duplication of an assembly instruction.

13. The method of claim 1, wherein the second binary file is linked with a third binary file to generate a machine-executable file, wherein the third binary file includes no fault countermeasures inserted by the compiler.

14. The method of claim 1, wherein the compiler is configured to insert an initial set of fault countermeasures into the first binary file during the compilation of the source code.

15. A system for automatically generating a compiled binary file with fault countermeasures, comprising:
one or more processors; and
a memory coupled to the one or more processors comprising instructions executable by the one or more processors to cause the system to:
compile, using a compiler, a source code file to a first binary file;
analyze the first binary file to identify one or more fault vulnerabilities in the first binary file, wherein analyzing the first binary file to identify the one or more fault vulnerabilities comprises:
injecting a set of faults into the first binary file during a symbolic execution of the first binary file to generate a set of faulted states of the first binary file; and
identifying the one or more fault vulnerabilities from the set of faulted states, wherein the one or more fault vulnerabilities are fault vulnerabilities that cause the first binary file to violate at least one security requirement; and
compile, using the compiler, the source code file to a second binary file, wherein the compiler inserts a set of fault countermeasures into the second binary file based on the identified one or more fault vulnerabilities, wherein the set of fault countermeasures protect the second binary file against the one or more fault vulnerabilities.

16. The system of claim 15, wherein analyzing the first binary file to identify the one or more fault vulnerabilities further comprises generating a reference trace representing a correct execution behavior of the first binary file.

17. The system of claim 15, wherein identifying the one or more fault vulnerabilities comprises identifying a location in the first binary file for each of the one or more fault vulnerabilities.

18. The system of claim 15, wherein the symbolic execution of the first binary file comprises providing a corrupted input to the first binary file, and wherein the one or more fault vulnerabilities comprises executing a software operation using the corrupted input.

19. The system of claim 15, wherein the set of faults comprises at least one of an instruction skip, load corruption, a register operand substitution, and a control flow branch operand substitution.

20. The system of claim 15, wherein the one or more fault vulnerabilities comprise at least one of a stack overflow, calling a sensitive function, bypassing an authentication, leaking a key to an external interface, and a code injection.

21. The system of claim 15, wherein the set of faults are injected at predefined locations of the first binary file.

22. The system of claim 15, wherein the set of fault countermeasures are inserted at an intermediate representation level of the source code during the compilation.

23. The system of claim 15, wherein the set of fault countermeasures are inserted at an assembly instruction level during the compilation.

24. The system of claim 15, wherein the set of fault countermeasures comprises at least one control flow integrity (CFI) countermeasure.

25. The system of claim 24, wherein the at least one CFI countermeasure comprises a first CFI countermeasure between one or more different functions of the second binary file and a second CFI countermeasure within a single function of the second binary file.

26. The system of claim 15, wherein the set of fault countermeasures comprises a duplication of an assembly instruction.

27. The system of claim 15, wherein the second binary file is linked with a third binary file to generate a machine-executable file, wherein the third binary file includes no fault countermeasures inserted by the compiler.

28. The system of claim 15, wherein the compiler is configured to insert an initial set of fault countermeasures into the first binary file during the compilation of the source code.

29. One or more computer-readable non-transitory storage media embodying software for automatically generating a compiled binary file with fault countermeasures, the software comprising instructions operable when executed to:
compile, using a compiler, a source code file to a first binary file;
analyze the first binary file to identify one or more fault vulnerabilities in the first binary file, wherein analyzing the first binary file to identify the one or more fault vulnerabilities comprises:
injecting a set of faults into the first binary file during a symbolic execution of the first binary file to generate a set of faulted states of the first binary file; and
identifying the one or more fault vulnerabilities from the set of faulted states, wherein the one or more fault vulnerabilities are fault vulnerabilities that cause the first binary file to violate at least one security requirement; and
compile, using the compiler, the source code file to a second binary file, wherein the compiler inserts a set of fault countermeasures into the second binary file based on the identified one or more fault vulnerabilities, wherein the set of fault countermeasures protect the second binary file against the one or more fault vulnerabilities.
